(19) United States
(12) Patent Application Publication
(10) Pub. No.: US 2008/0044096 A1
(43) Pub. Date: Feb. 21, 2008

(54) Scanner Authentication

(75) Inventors: Russell Paul Cowburn, Gerrards Cross (GB); James David Ralph Buchanan, London (GB); Peter Robert Seem, London (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: INGENIA HOLDINGS (UK) LIMITED, London (GB)

(21) Appl. No.: 11/761,241

(22) Filed: Jun. 11, 2007

Related U.S. Application Data
(60) Provisional application No. 60/804,537, filed on Jun. 12, 2006.

(30) Foreign Application Priority Data
Jun. 12, 2006 (GB) GB 0611618.0

(51) Int. Cl. G06K 9/46

(52) U.S. Cl. 382/238

(57) ABSTRACT

A method of creating a signature for an article can be provided. The method can comprise illuminating regions of the article sequentially by light at non-normal incidence and detecting light reflected from the surface of each region of the article. The method can further comprise processing signals representative of the reflected light from each region, the signals being indicative of a surface roughness of the region, to determine a signature for the article.

### RELATED APPLICATIONS

This application claims the benefit under 35 U.S.C. § 119(a-e) of U.S. provisional application Ser. No. 60/804,537, filed Jun. 12, 2006, and Great Britain patent application GB 0611618.0, filed Jun. 12, 2006, the contents of which are hereby incorporated herein by reference.

### FIELD

The present invention relates to scanner authentication, and in particular, but not exclusively, to use of a conventional flatbed scanner type apparatus for the authentication of documents made of paper, plastics or metals.

### BACKGROUND

Many traditional authentication security systems rely on a process which is difficult for anybody other than the manufacturer to perform, where the difficulty may be imposed by expense of capital equipment, complexity of technical know-how or preferably both. Examples are the provision of a watermark in bank notes and a hologram on credit cards or passports. Unfortunately, criminals are becoming more sophisticated and can reproduce virtually anything that original manufacturers can do.

Because of this, there is a known approach to authentication security systems which relies on creating security tokens using some process governed by laws of nature which results in each token being unique, and more importantly having a unique characteristic that is measurable and can thus be used as a basis for subsequent verification. According to this approach tokens are manufactured and measured in a set way to obtain a unique characteristic. The characteristic can then be stored in a computer database, or otherwise retained. Tokens of this type can be embedded in the carrier article, e.g. a banknote, passport, ID card, important document. Subsequently, the carrier article can be measured again and the measured characteristic compared with the characteristics stored in the database to establish if there is a match.

James D. R. Buchanan et al in “Forgery: ‘Fingerprinting’ documents and packaging”, Nature 436, 475-475 (28 Jul. 2005) describes a system for using reflected laser light from an article to uniquely identify the article with a high degree of reproducability not previously attained in the art. Buchanan's technique samples reflections from an article surface a number of times at each of multiple points in the surface to create a signature or “fingerprint” for the article.

The system described therein uses a focussed coherent light beam to illuminate regions or points on the surface of an article and detects reflections of that light from the surface which carry information describing surface roughness or texture of that surface.

The present invention has been conceived in the light of known drawbacks of existing systems.

### SUMMARY

The inventors' investigations into optical techniques for optically obtaining information describing the surface roughness or texture of an article and for obtaining a signature which identifies that particular article from other similar (macroscopically identical or similar) articles has led to the present invention, in which a conventional flatbed type scanner apparatus can be used to perform the optical scanning of the article. The signals from the scanner can then be processed to create a signature.

Viewed from a first aspect, the invention can provide a method of creating a signature for an article, the method comprising: illuminating regions of the article sequentially by light at non-normal incidence; detecting light reflected from the surface of each region of the article; and processing signals representative of the reflected light from each region, the signals being indicative of a surface roughness of the region, to determine a signature for the article.

This provides for the apparatus used to create the signature being a conventional, commonly available, computer peripheral that many computer users already own. Thus, adoption of a system of using authentication signatures to validate or authenticate physical articles such as printed documents or entitlement tokens (such as credit cards, debit cards and loyalty cards) is not dependent upon a user obtaining a new and unfamiliar piece of equipment.

The scanning can be carried out by any conventional scanner which illuminates a scan target with light of non-normal incidence to the scan target. Suitable scanners include many conventional flatbed type scanners (where an article is positioned against a scanning platen and a scan head moves relative to the article), sheetfeed type scanners (where an article is carried past a scan head) and handheld type scanners (where a scan unit is moved relative to an article by a user). Some such scanners may be incorporated into so-called multi-function devices which include printing apparatus in the same device so as to provide for one device to provide scanning, copying, printing and sometimes (where an appropriate interface is provided) faxing. Some scanners may be part of digital photocopiers, such as those which can be connected to a networked computer system as an autonomous printing/copying/scanning resource. In such an example, a signature generation module could be provided in, for example, the firmware controlling the operation of the digital photocopier.

An article may be authenticated by a system where a first or record signature is created for an article and stored in a database of signatures. Subsequently, possibly at a different location, the article can be scanned again and a second or verification signature created. The verification signature can be compared to the database of record signatures. If a match is discovered, then the article from which the verification signature was generated can be considered as genuine.

An alternative systems, the signature created from a scanned document can be associated with an electronic copy of that document within a computer environment. By setting control parameters for the document, permissions may be set for both electronic and physical (e.g. printing or faxing) reproduction of the document. Such signatures can also be used to restrict or record copy making from a document. For example, a record signature for a document may be associated with reproduction permissions. When a user attempts to copy or fax the document, a signature of the document is taken, and compared to a database of record signatures to find a matching record signature and associated copy permissions. In dependence upon those permissions, the user may be prevented from copying or faxing the document, or may be permitted to copy or fax the document, in some cases in dependence upon a security or clearance parameter provided by the user.

Viewed from a further aspect, the present invention can provide a system for creating a signature for an article. The system can comprise a light source operable to direct light toward regions of the article sequentially at non-normal incidence, and a detector operable to detect light reflected from the surface of each region of the article. The system can also comprise a processor operable to process signals representative of the reflected light from each region, the signals being indicative of a surface roughness of the region, to determine a signature for the article.

This provides for the apparatus used to create the signature being a conventional, commonly available, computer peripheral that many computer users already own. Thus, adoption of a system of using authentication signatures to validate or authenticate physical articles such as printed documents or entitlement tokens (such as credit cards, debit cards and loyalty cards) is not dependent upon a user obtaining a new and unfamiliar piece of equipment.

In some examples, the detector can comprise a lens array operable to focus the reflected light onto a photodetector array, each lens in the lens array corresponding to a respective photodetector, and each lens in the lens array being configured to collect light reflected from a respective different part of the region for each region. Thus, the whole width of an article may be scanned in a single pass, with multiple sensors being provided to divide each strip (region) of the scan area into smaller parts.

In some examples, to aid searching through multiple signatures, each signature can have calculated therefor a thumbnail signature smaller than the whole signature to speed a search process.

The present invention can also provide a system for authenticating an article. The system can comprise a system as discussed above, operable to create a first signature for the article, and a store operable to store the first signature. The system can also comprise a system as discussed above, operable to create a second signature for the article, and a comparator operable to compare the second signature to the stored first signature to determine whether the same article has been used to create both signatures. Thereby an article can be validated against a previously stored signature to verify that the article is genuine.

Further objects and advantages of the invention will become apparent from the following description and the appended claims.

### BRIEF DESCRIPTION OF THE DRAWINGS

For a better understanding of the invention and to show how the same may be carried into effect reference is now made by way of example to the accompanying drawings in which:

FIG. 1 shows a schematic sectional view of a document scanner;

FIG. 2 shows a schematic perspective view of the scanner of FIG. 1;

FIGS. 3A and 3B show prints of electronic images obtained when a sheet of paper is scanned on two separate occasions using a document scanner;

FIGS. 4A and 4B show a selected region of the electronic image represented in FIG. 3A and an enlarged, contrast adjusted section of that image;

FIG. 5 shows an intensity plot for the image of FIG. 3A;

FIG. 6 shows an intensity plot for the image of FIG. 3B;

FIG. 7 shows a comparison of the plots of FIGS. 5 and 6;

FIG. 8 shows a plot of a cross-correlation between the data sets used to create the plots of FIGS. 5 and 6;

FIG. 9 shows an enlargement of a part of the plot of FIG. 8;

FIG. 10 shows a comparison of plots of data from scans of two different articles;

FIG. 11 shows a plot of a cross-correlation between the data sets used to create the plot of FIG. 10;

FIG. 12 is a microscope image of a paper surface with the image covering an area of approximately 0.5×0.2 mm;

FIG. 13 is a microscope image of a plastic surface with the image covering an area of approximately 0.02×0.02 mm;

FIG. 14 is a flow diagram showing how a signature of an article is generated from a scan;

FIG. 15 is a flow diagram showing how a signature of an article obtained from a scan can be verified against a signature database;

FIG. 16a is a plot illustrating how a number of degrees of freedom can be calculated;

FIG. 16b is a plot illustrating how a number of degrees of freedom can be calculated;

FIG. 17 is a flow diagram showing how the verification process of FIG. 40 can be altered to account for non-idealities in a scan;

FIG. 18A shows an example of cross-correlation data gathered from a scan;

FIG. 18b shows an example of cross-correlation data gathered from a scan where the scanned article is distorted;

FIG. 18C shows an example of cross-correlation data gathered from a scan where the scanned article is scanned at non-linear speed; and

FIG. 19 shows schematically a database structure for storing record signatures.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### SPECIFIC DESCRIPTION

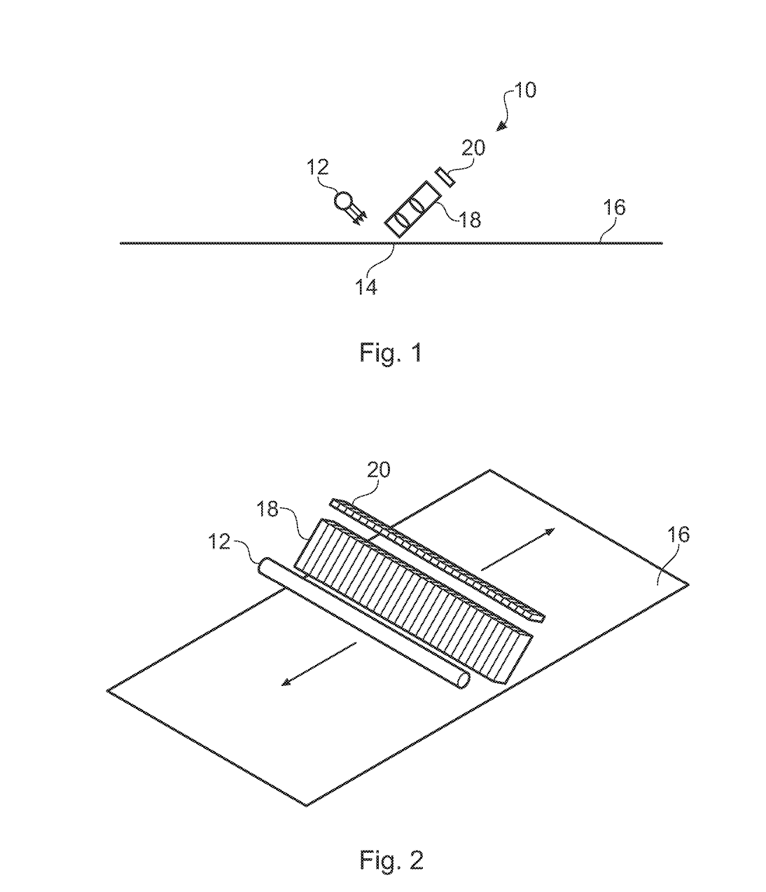

FIG. 1 shows a schematic sectional view of a flatbed scanning apparatus 10. As mentioned above, the scanning apparatus could be apart of, for example, a dedicated scanner, a so-called multi-function device or a digital photocopier. The apparatus 10 includes a light source 12 for illuminating a scan target. In many flatbed scanner-type devices, the light source may be a cold cathode fluorescent lamp, a xenon lamp, a conventional fluorescent lamp or a light emitting diode (LED) or LED array. In most scanners, some form of light guide (not shown) is provided to direct the light toward the target, either by reflecting light travelling in the “wrong” direction toward the target or by absorbing light travelling in the “wrong” direction or both.

The light hits a scan target (not shown) arranged on a support 16 at about position 14. The light then reflects from the scan target and is picked up by a lens arrangement 18. The lens arrangement focuses the light reflected from the scan target onto a light sensor 20. The lens arrangement also acts as in interference filter to ensure that only light travelling roughly perpendicularly to the sensor 20 actually reaches it. This helps to prevent the sensor receiving light from too large an area and therefore reducing the accuracy of the scan result. The sensor element 20 is, in many scanner devices, a photosensitive device such as a charge-coupled-device (CCD).

As shown in FIG. 2, many scanner devices utilise a light source 12, lens arrangement array 18 and detector array 20 stretching across the width of a scan target support platen 16. The light source, lens arrangement and sensor array make up a scan head, which moves relative to the scan target to cause the entire scan target to be captured in sequential capture operations.

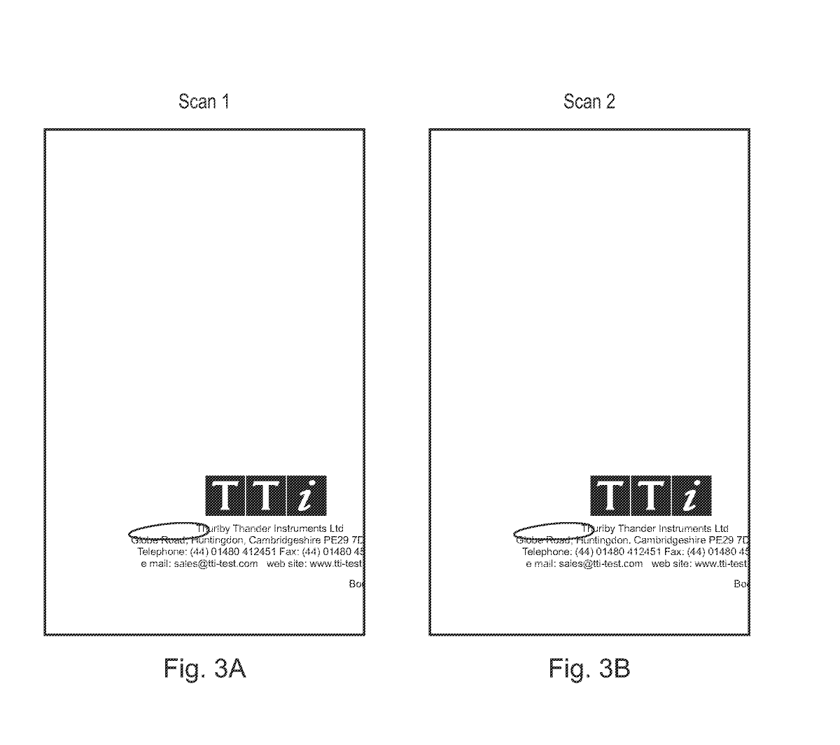

Thus, the operation of a conventional scanner apparatus is understood. The application of such an apparatus to a signature generation and authentication system will now be described with reference to FIGS. 3 to 9.

FIGS. 3A and 3B show first and second images captured by scanning a single sheet of “white” paper twice using a flatbed scanner. As would be expected, these images appear white and identical. In order to provide for there to be something to see in these figures, the paper used as the target of the scan had printed writing thereon. The nature of the writing is irrelevant, as are any other visible marks on the paper.

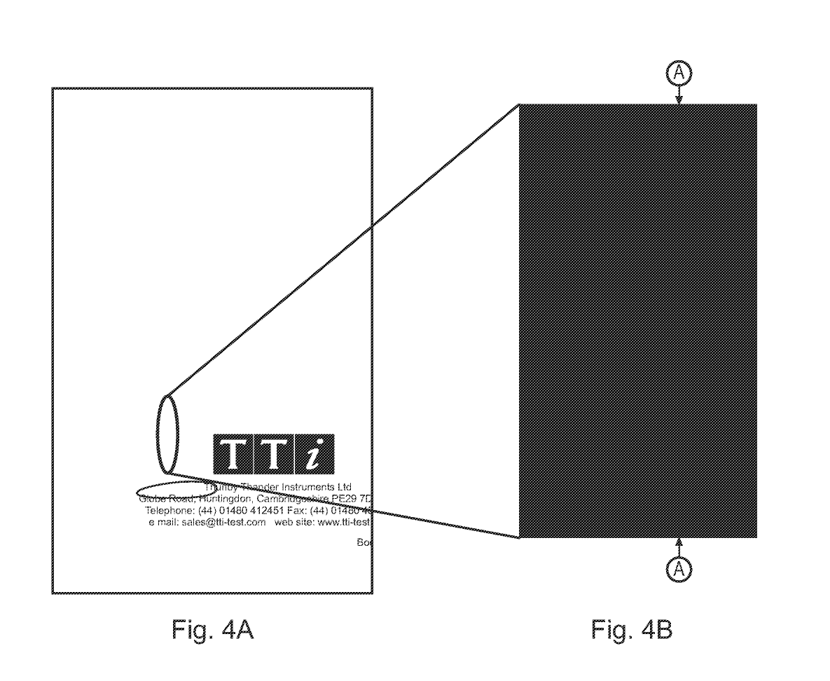

FIG. 4A shows a selected region of one of the scanned images, and FIG. 4B shows this selected region magnified and with adjusted contrast and brightness. With this contrast adjustment, it becomes clear that the “white” image actually carried some shade information. This shade information is not visible when the image is viewed at “normal” contrast. In fact, if the entire image were viewed at the contrast level used in FIG. 4B, it would not be possible to see the printed elements visible in FIG. 4A.

This shade information carries information describing the surface roughness of the paper. In FIG. 4B, where the imaged sheet of paper is A4 sized, the enlarged region is approximately 1 cm by 2 cm. If the scanner captures at a resolution of 1200 DPI (1200 dots per 25.4 mm), this gives a granularity (dot size) of approximately 400 m² (i.e. 20 μm squared).

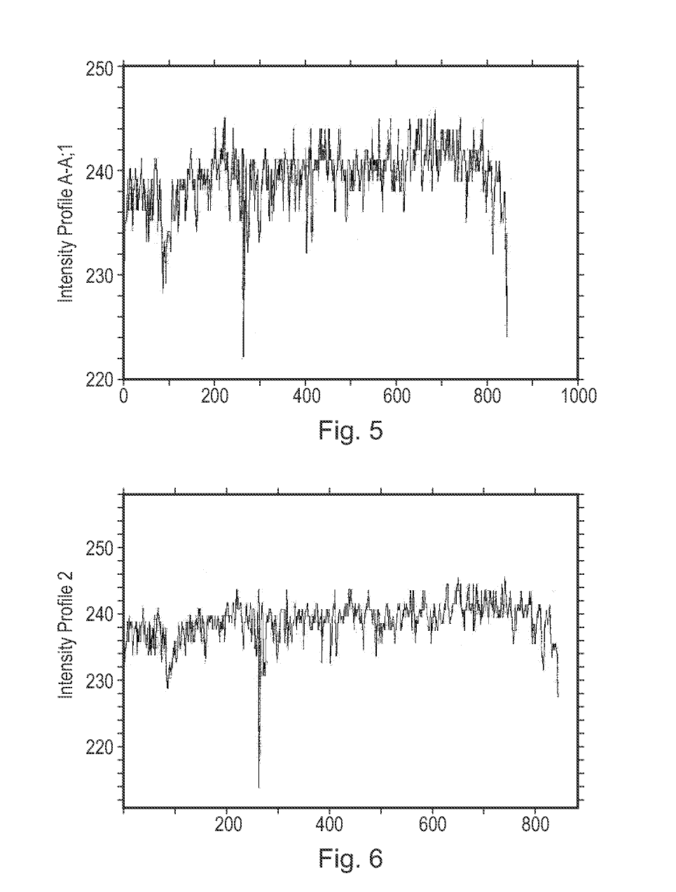

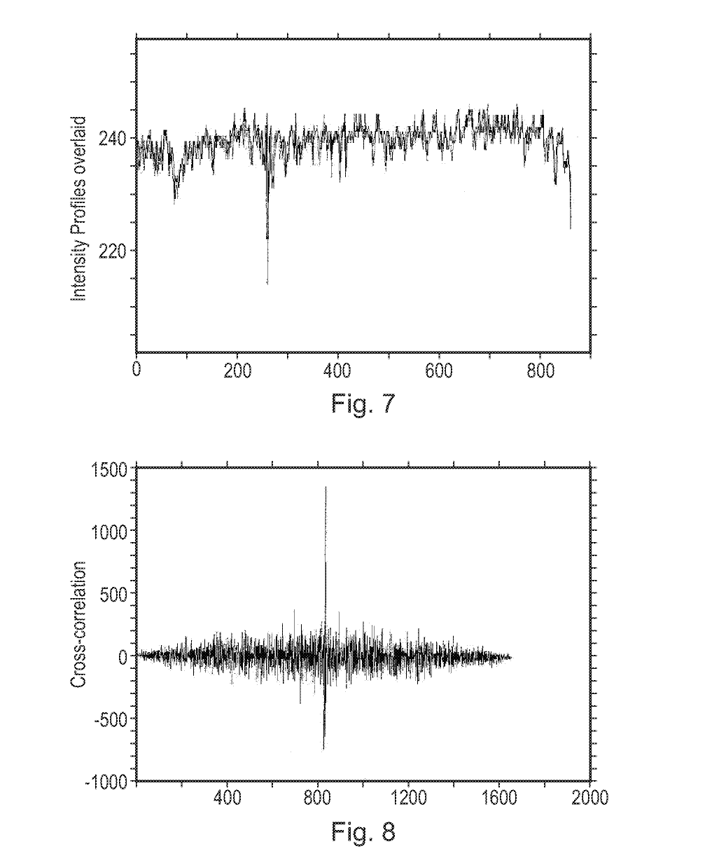

FIG. 5 shows a plot of detected signal intensity along the line AA in the first scan (FIG. 3A) of the paper (marked in FIG. 4B). The graph plots a numerical intensity value against (y-axis) for each detected pixel along the reading line AA (x-axis). The numerical intensity value is obtained by dividing the full intensity of the scanner over the 8-bit (0-255) range of the image from the scanner FIG. 6 shows an equivalent plot for the second scan (FIG. 3B). Taking into account the differing scales of these two plots, it can be seen that the intensity lines for the two scans are very similar. In fact, if these two plots are overlaid against one another as shown in FIG. 7, it can be seen just how similar these two plots are. By way of confirmation of this similarity, the results of a cross-correlation between the data from the two different scans is shown in FIG. 8. This graph plots the cross correlation sum (y-axis) against the pixel offset (i.e. shift value) between the two data sets. Thus it is very clear that this intensity information is reproduced in multiple scans of the same object, thus allowing a test between multiple scans of the same object to be used to determine whether the two scans are of the same object.

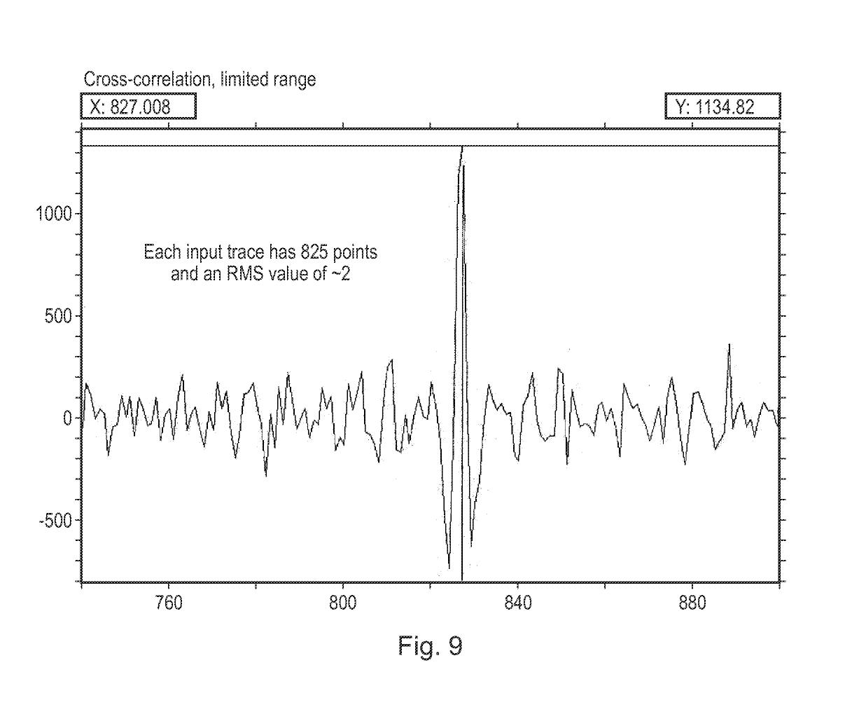

FIG. 9 shows a magnified portion of the cross-correlation plot of FIG. 8. In the data sets used to create FIGS. 8 and 9, each set of data contained 825 data points, and the RMS value of each data set was ˜2. From FIG. 9, it is clear that the cross-correlation peak occurs at a pixel offset value of approximately 825 (i.e. almost exactly 1:1 alignment between the data sets) and has a peak value of 1335. Given that each data set contains 825 points, the theoretical perfect match would have a peak value of 1650. However, as each scan of the paper provides very slightly different results (as do all biometric-type measures of a random characteristic such as surface roughness), the actual peak is slightly below this (at 1335), which drop is a reflection of the value of the RMS of the data sets.

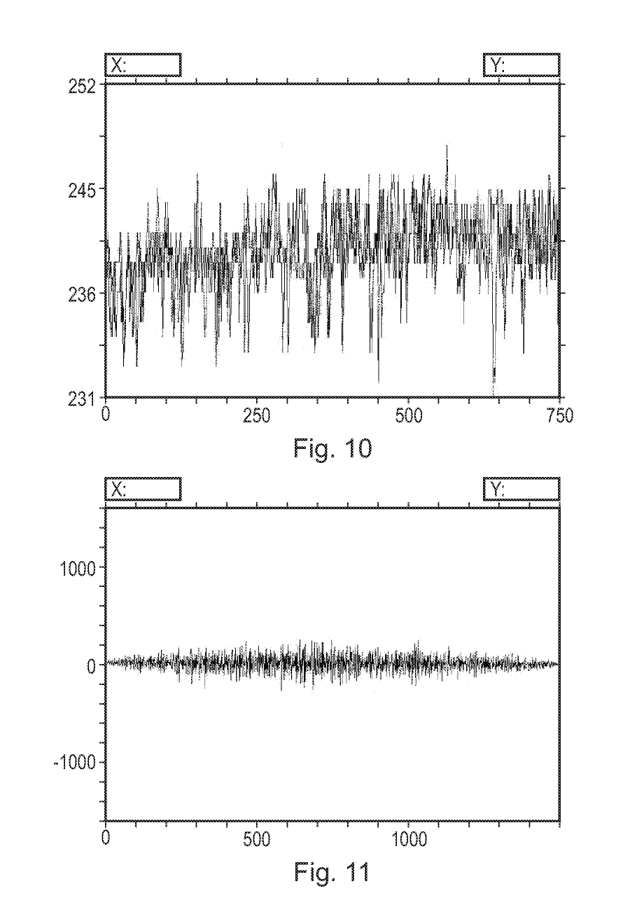

By way of example, FIGS. 10 and 11 show equivalent data for a comparison between two different sheets of paper. This also applies equally to data from two different parts of the same sheet of paper. FIG. 10 is a plot showing intensity profiles from two such different scans overlaid. It is clear from this that the plots are very dissimilar. This is confirmed by FIG. 11 which is a cross-correlation plot of the two data sets from the scans of the two different sheets of paper. As is clear from FIG. 11, there is no clear peak which indicates very clearly that these data sets are very different.

It is believed that this system works because the light incident on the target article creates shadows on the surface of the article caused by the surface roughness of the article. That shadow information, which describes the surface roughness of the article, is carried in the reflected light detected by the scan head. Thereby, any article which has surface roughness (i.e. is not optically smooth) can have a signature generated therefor using this technique. This captured shadow information, provides a description of the surface roughness or texture which is equivalent to that provided in the “speckle”—type reflection data described by Buchanan.

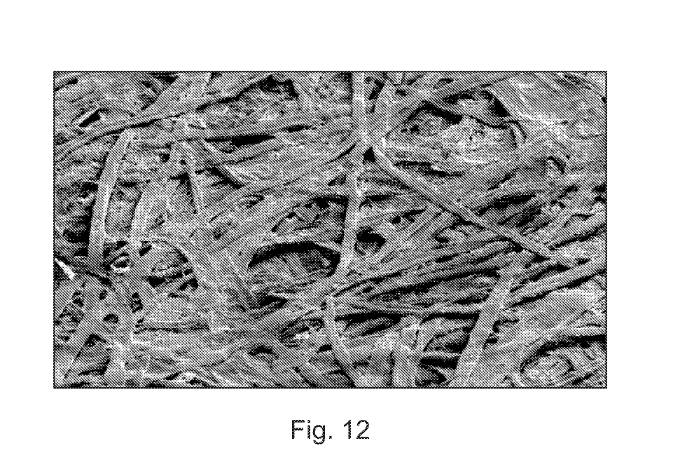

This surface roughness is illustrated, by way of example, in FIG. 12 which shows a microscope image of a paper surface with the image covering an area of approximately 0.5×0.2 mm. This figure is included to illustrate that macroscopically flat surfaces, such as from paper, are in many cases highly structured at a microscopic scale. For paper, the surface is microscopically highly structured as a result of the intermeshed network of wood fibres that make up paper. The figure is also illustrative of the characteristic length scale for the wood fibres which is around 10 microns. This dimension has the correct relationship to the optical wavelength of at least some of the incident light to cause shadow information from the paper to be visible in detected reflection. It will thus be appreciated that if a scanner is to be designed for a specific class of goods, the wavelength of the light can be tailored to the structure feature size of the class of goods to be scanned. It is also evident from the figure that the local surface structure of each piece of paper will be unique in that it depends on how the individual wood fibres are arranged. A piece of paper is thus no different from a specially created token, such as the special resin tokens or magnetic material deposits of the prior art, in that it has structure which is unique as a result of it being made by a process governed by laws of nature. The same applies to many other types of article.

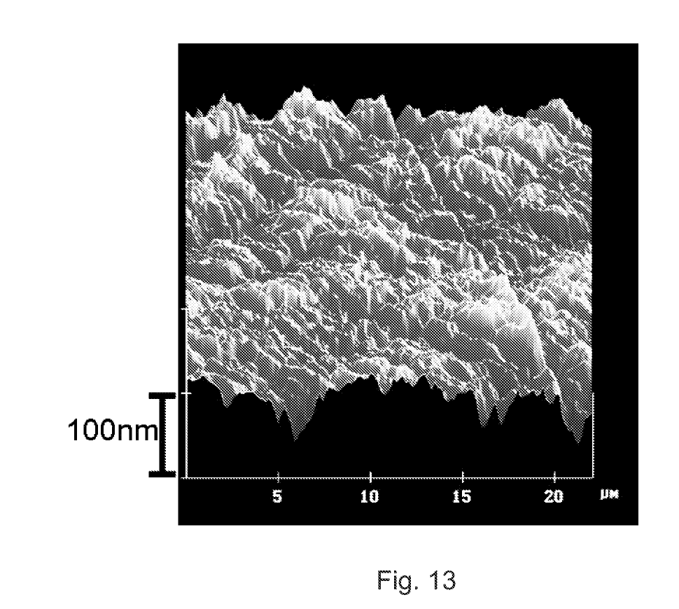

FIG. 13 shows an equivalent image for a plastic surface. This atomic force microscopy image clearly shows the uneven surface of the macroscopically smooth plastic surface. As can be surmised from the figure, this surface is smoother than the paper surface illustrated in FIG. 12, but even this level of surface undulation can be uniquely identified using the signature generation scheme of the present examples.

In other words, the inventor has discovered that it is essentially pointless to go to the effort and expense of making specially prepared tokens, when unique characteristics are measurable in a straightforward manner from a wide variety of every day articles. The data collection and numerical processing of a scatter signal that takes advantage of the natural structure of an article's surface (or interior in the case of transmission) is now described.

Thus, there has now been described an example of a system which can be used to collect surface roughness data for a target article and examples of the data which can be gathered from such apparatus.

Although the system of the present examples provides the significant advantage of allowing readily available apparatus to be used for generating a signature for an article, it also suffers certain deficiencies when compared to the systems described by Buchanan. These relative advantages/disadvantages represent a trade-off between certain features which the user of such a system can weigh up for themselves to determine which system would be most appropriate for them.

For example, the extremely shallow depth of field of a typical flatbed scanner, which is caused by the incident light being unfocussed such that the focus is entirely dependent upon the lenses used on the sensor side, means that the system is extremely sensitive to damage caused by, for example folding or crumpling of a paper article. This drawback can be countered by using an extremely large signature size (perhaps based on hundreds of thousands or even millions of data points). Although the data handling capacity of a system to implement this would need to be large, the increased signature size provides increased robustness to damage to an article. This is because although where an article is damaged the bit error rate (expressed as a fraction of the total number of bits) is likely to remain approximately constant as the scan area increases, but the statistical significance (in terms of uniqueness) of a given error rate reduces as the number of bits increases, due to the increasing total number of bits. Thus even a damaged article may be successfully re-identified if a large enough total number of bits are used.

Also, although the system of the present examples is efficient for processing of paper documents or the like, it could not be used in a production line environment where the distance from the scan head to the article cannot be guaranteed. For example, even if the scan head were to be mounted onto a surface across which articles are moved in the production line, the vibrations present in a typical production line environment would be sufficient to move articles out of the very narrow depth of field afforded by the optical system.

Additionally, because a conventional flatbed type scanner has only a single detector array, the system is susceptible to spoofing. If a fraudster were to be able to make his own scan of a secured document, he would be able to analyse the observed pattern and devise a printed pattern which could be applied to the surface of another document which would cause that second document to appear to have the same surface as the secured document. Thus, a scan of the second, fraudulent, document would provide a signature sufficiently similar to that of the genuine secured document for the fraudulent document to be accepted as the genuine secured document. If a second detector array were to be added at a different angle to the article surface, this kind of spoofing would be impossible, as the pattern needed to be printed onto the surface to fool the first detector array would be different to the pattern needed to fool the second detector array. It will be understood that this printed pattern based spoofing relies upon the fact than a given surface roughness can, when observed from a given angle, be imitated by a printed pattern which would cause the same reflectivity pattern from an article surface. However, as the observed pattern from the surface roughness changes with observation angle, so the printed pattern needed to fool the system changes. If two detectors are used at different angles, so two different printed patterns are required to be present on the same piece of paper simultaneously—a physical impossibility which even the most sophisticated criminals have yet to achieve. However, as a typical document scanner requires to output only a single electronic image of a document, such scanner tend to have only a single detector array.

One way of achieving the equivalent of two scan heads in a single scan head device is to scan the article twice, at 0° and 180° orientations. Thereby, the article is read with the light appearing to come from both directions. This system is not foolproof as a clever fraudster might be able to use two separate sheets, each appropriately printed, for the two different scan operations, but this would offer a higher level of security for at least some systems.

In the following, a description of the processing which can be performed to create a signature from the captured data will be provided.

Firstly, the amount of data available can be considered. If an entire A4 size (210×297 mm) document is scanned at a resolution of 1200 DPI (1200 dots per 25.4 mm), this provides a total of 139,201,551 data points. This represents a huge amount of data, so for many applications, a subset of this data may be used.

A subset of the data can be chosen in one of two ways. The first is to select a small region of the document surface upon which to base the signature. The second is to select a subset of the captured data points from the whole document surface upon which to base the signature.

The first method does not detect tampering to other parts of the document surface, and is less robust to localised damage to the document in the scan region, but advantageously requires less accurate placement of the document on a scanner apparatus.

The second method is robust to localised damage to the document, and may be more likely to detect tampering with the document, but is more sensitive to placement of the document on the scanner. This is because the larger any single contiguous block of data points is, the greater the room for error in positioning the document for scanning. Taking the extreme example of each data point used in the signature being an individual point on the surface, the paper must be aligned with an accuracy of 20 μm in each direction. This difficulty can be overcome if the stored signature (based on a subset) is compared to a scan of the entire surface, but this increases the amount of data to be handled again.

For many applications where little or no object damage is expected, a total of 250 to 10,000 data points might be used for each signature. On the other hand, if a large amount of surface degradation is expected (perhaps a credit card which will repeatedly be placed in and removed from a wallet and repeatedly swiped through reading apparatus) a much large number of data points could be used, perhaps as many as 100,000 to 1,000,000.

Where a reasonably large scan area is in use (e.g 10 mm×10 mm or larger), a positioning of the document on the scanner can simply be made using the positioning guides provided by many scanners, whether an alignment mark or frame on a flatbed scanner, or a sheet feeder in a sheet-feed scanner.

Once the set of data from the scan area which is to be used for creating the signature has been selected, an averaging function can be applied to the selected points from which data has been collected. In one example, this effectively takes the form of multiplying a 1-dimensional vector of data points by a random scrambling matrix. This provides information about the surface as a whole and is resistant to partial damage to the surface of the scan area yet does not increase the data volume for the signature. In one example, the scrambling matrix can be made up of integer (effectively digital) values +1, 0, −1, which makes the logic required to perform the multiplication operation simple but may artificially increase the bit error rate (BER) in the signature. In another example, the scrambling matrix can be made up of analog values with gaussian weights, which avoids any increase to the BER, but requires more complex logic to perform the multiplication calculations.

Having decided on a set of data points to use for the signature, the processing to be carried out to achieve a usable signature needs to be considered.

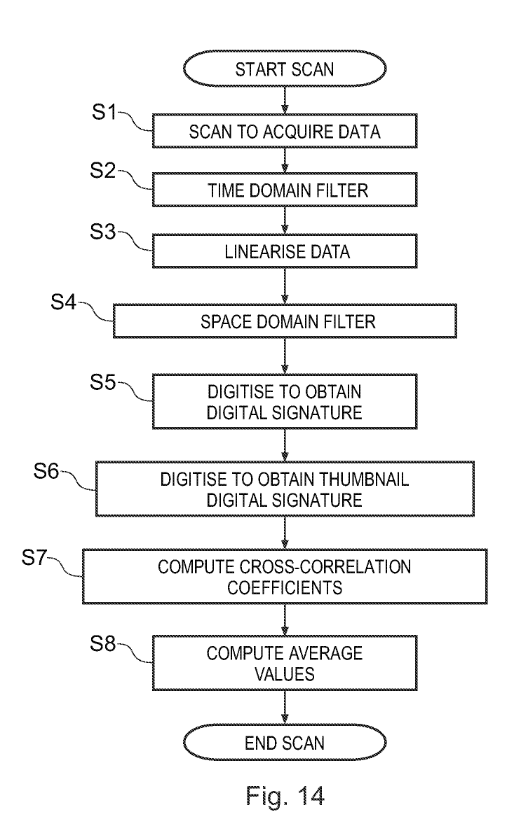

FIG. 14 is a flow diagram showing how a signature of an article can be generated from a scan.

Step S1 is a data acquisition step during which the optical intensity at each of the photodetectors is acquired at a number of locations along the entire length of scan. It is noted that if the scan motor has a high degree of linearisation accuracy (e.g. as would be the case in most flatbed scanners), or if non-linearities in the data can be removed through block-wise analysis or template matching, then linearisation of the data may not be required. The number of data points per photodetector collected in each scan is defined as N in the following. Further, the value aₖ(i) is defined as the i-th stored intensity value from photodetector k, where i runs from 1 to N. In the present example, where a typical scanner has only a single detector array, k=1.

Step S2 is an optional step of applying a time-domain filter to the captured data. In the present example, this is used to selectively remove signals in the 50/60 Hz and 100/120 Hz bands such as might be expected to appear if the target is subject to illumination from, for example, fluorescent sources. These frequencies are those most commonly used for driving room lighting such as fluorescent lighting.

Step S3 performs alignment of the data. In some examples, this step uses numerical interpolation to locally expand and contract aₖ(i) so that the encoder transitions are evenly spaced in time. This corrects for local variations in the motor speed and other non-linearities in the data.

In some examples, where the scan area corresponds to a predetermined pattern template, the captured data can be compared to the known template and translational and/or rotational adjustments applied to the captured data to align the data to the template. Also, stretching and contracting adjustments may be applied to the captured data to align it to the template in circumstances where passage of the scan head relative to the article differs from that from which the template was constructed. Thus if the template is constructed using a linear scan speed, the scan data can be adjusted to match the template if the scan data was conducted with non-linearities of speed present.

Step S4 applies a space-domain band-pass filter to the captured data. This filter passes a range of wavelengths in the x-direction (the direction of movement of the scan head). The filter may also be configured to work in the y-direction (across the width of the scan head) to provide a 2-D spatial filter. The filter is designed to maximise decay between samples and maintain a high number of degrees of freedom within the data. With this in mind, the lower limit of the filter passband is set to have a fast decay. This is required as the absolute intensity value from the target surface is uninteresting from the point of view of signature generation, whereas the variation between areas of apparently similar intensity is of interest. However, the decay is not set to be too fast, as doing so can reduce the randomness of the signal, thereby reducing the degrees of freedom in the captured data. The upper limit can be set high; whilst there may be some high frequency noise or a requirement for some averaging (smearing) between values in the x-direction (much as was discussed above for values in the y-direction), there is typically no need for anything other than a high upper limit. In terms of the order of the filter, it is generally desirable to minimise the occurrence of ringing which can cause oscillations in the captured data. Therefore a low order filter may be used. In some examples a zeroth order filter may be used. In some examples, the filter may have a different effect in the x- and y-directions, for example it could be zeroth order in the y-direction and first order in the x-direction. In one example, where the speed of travel of the scan head over the target surface is 20 mm per second, the filter may have an impulse rise time of 1 ms and an impulse fall time of 5 ms.

Instead of applying a simple filter, it may be desirable to weight different parts of the filter. In one example, the weighting applied is substantial, such that a triangular passband is created to introduce the equivalent of realspace functions such as differentiation. A differentiation type effect may be useful for highly structured surfaces, as it can serve to attenuate correlated contributions (e.g. from surface printing on the target) from the signal relative to uncorrelated contributions.

Step S5 is a digitisation step where the multi-level digital signal (the greyscale or colour intensity pixel values output from the scanner) is converted to a bi-state digital signal to compute a digital signature representative of the scan. The digital signature is obtained in the present example by applying the rule: aₖ(i)>mean maps onto binary ‘1’ and aₖ(i)<=mean maps onto binary ‘0’. The digitised data set is defined as dₖ(i) where i runs from 1 to N. The signature of the article may advantageously incorporate further components in addition to the digitised signature of the intensity data just described. These further optional signature components are now described.

Step S6 is an optional step in which a smaller ‘thumbnail’ digital signature is created. In some examples, this can be a realspace thumbnail produced either by averaging together adjacent groups of m readings, or by picking every cth data point, where c is the compression factor of the thumbnail. The latter may be preferable since averaging may disproportionately amplify noise. In other examples, the thumbnail can be based on a Fast Fourier Transform of some or all of the signature data. The same digitisation rule used in Step S5 is then applied to the reduced data set. The thumbnail digitisation is defined as tₖ(i) where i runs 1 to N/c and c is the compression factor.

Step S7 is an optional step applicable when multiple detector channels exist. In the present examples, this would only occur if a specialised multi-detector array scanner were to be used. Conventional scanners have only a single sensor array as only a single electronic image is generally required of a scanned object. The additional component is a cross-correlation component calculated between the intensity data obtained from different ones of the photodetectors. With 2 channels there is one possible cross-correlation coefficient, with 3 channels up to 3, and with 4 channels up to 6 etc. The cross-correlation coefficients can be useful, since it has been found that they are good indicators of material type. For example, for a particular type of document, such as a passport of a given type, or laser printer paper, the cross-correlation coefficients always appear to lie in predictable ranges. A normalised cross-correlation can be calculated between aₖ(i) and aₗ(i), where k≠1 and k,l vary across all of the photodetector channel numbers. The normalised cross-correlation function is defined as:

$$Γ ( k , l ) = \frac{{\sum }_{i = 1}^{N} {a}_{k} ( i ) {a}_{l} ( i )}{\sqrt{( {\sum }_{i = 1}^{N} {{a}_{k} ( i )}^{2} ) ( {\sum }_{i = 1}^{N} {{a}_{l} ( i )}^{2} )}}$$

Another aspect of the cross-correlation function that can be stored for use in later verification is the width of the peak in the cross-correlation function, for example the full width half maximum (FWHM). The use of the cross-correlation coefficients in verification processing is described further below.

Step S8 is another optional step which is to compute a simple intensity average value indicative of the signal intensity distribution. This may be typically be an average for the entire detector array, such as a root mean square (rms) value of aₖ(i). The intensity value has been found to be a good crude filter for material type, since it is a simple indication of overall reflectivity and roughness of the sample. For example, one can use as the intensity value the unnormalised rms value after removal of the average value, i.e. the DC background. The rms value provides an indication of the reflectivity of the surface, in that the rms value is related to the surface roughness.

The signature data obtained from scanning an article can be compared against records held in a signature database for verification purposes and/or written to the database to add a new record of the signature to extend the existing database and/or written to the article in encoded form for later verification with or without database access.

A new database record will include the digital signature obtained in Step S5 as well as optionally its smaller thumbnail version obtained in Step S6 for each photodetector channel, the cross-correlation coefficients obtained in Step S7 and the average value(s) obtained in Step S8. Alternatively, the thumbnails may be stored on a separate database of their own optimised for rapid searching, and the rest of the data (including the thumbnails) on a main database.

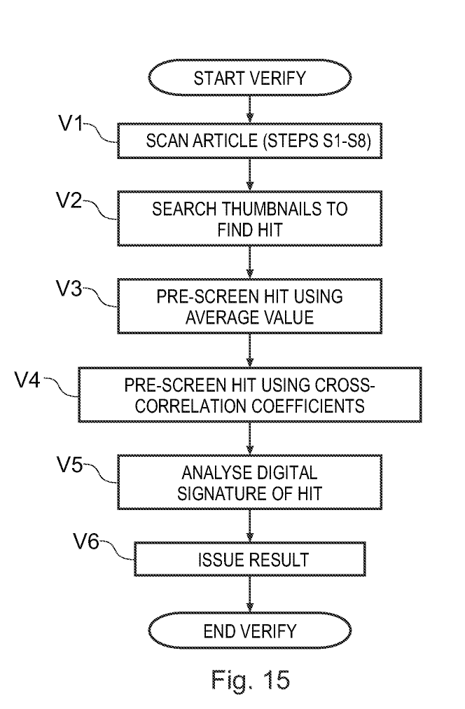

FIG. 15 is a flow diagram showing how a signature of an article obtained from a scan can be verified against a signature database.

In a simple implementation, the database could simply be searched to find a match based on the full set of signature data. However, to speed up the verification process, the process of the present example uses the smaller thumbnails and pre-screening based on the computed average values and cross-correlation coefficients as now described. To provide such a rapid verification process, the verification process is carried out in two main steps, first using the thumbnails derived from the amplitude component of the Fourier transform of the scan data (and optionally also pre-screening based on the computed average values and cross-correlation coefficients) as now described, and second by comparing the scanned and stored full digital signatures with each other.

Verification Step V1 is the first step of the verification process, which is to scan an article according to the process described above, i.e. to perform Scan Steps S1 to S8. This scan obtains a signature for an article which is to be validated against one or more records of existing article signatures

Verification Step V2 seeks a candidate match using the thumbnail derived from the Fourier transform amplitude component of the scan signal, which is obtained as explained above with reference to Scan Step S6. Verification Step V2 takes each of the thumbnail entries and evaluates the number of matching bits between it and tₖ(i+j), where j is a bit offset which is varied to compensate for errors in placement of the scanned area. The value of j is determined and then the thumbnail entry which gives the maximum number of matching bits. This is the ‘hit’ used for further processing. A variation on this would be to include the possibility of passing multiple candidate matches for full testing based on the full digital signature. The thumbnail selection can be based on any suitable criteria, such as passing up to a maximum number of, for example 10, candidate matches, each candidate match being defined as the thumbnails with greater than a certain threshold percentage of matching bits, for example 60%. In the case that there are more than the maximum number of candidate matches, only the best 10 are passed on. If no candidate match is found, the article is rejected (i.e. jump to Verification Step V6 and issue a fail result).

This thumbnail based searching method employed in the present example delivers an overall improved search speed, for the following reasons. As the thumbnail is smaller than the full signature, it takes less time to search using the thumbnail than using the full signature. Where a realspace thumbnail is used, the thumbnail needs to be bit-shifted against the stored thumbnails to determine whether a “hit” has occurred, in the same way that the full signature is bit-shifted against the stored signature to determine a match. The result of the thumbnail search is a shortlist of putative matches, each of which putative matches can then be used to test the full signature against.

Where the thumbnail is based on a Fourier Transform of the signature or part thereof, further advantages may be realised as there is no need to bit-shift the thumbnails during the search. A pseudo-random bit sequence, when Fourier transformed, carries some of the information in the amplitude spectrum and some in the phase spectrum. Any bit shift only affects the phase spectrum, however, and not the amplitude spectrum. Amplitude spectra can therefore be matched without any knowledge of the bit shift. Although some information is lost in discarding the phase spectrum, enough remains in order to obtain a rough match against the database. This allows one or more putative matches to the target to be located in the database. Each of these putative matches can then be compared properly using the conventional real-space method against the new scan as with the realspace thumbnail example.

Verification Step V3 is an optional pre-screening test that is performed before analysing the full digital signature stored for the record against the scanned digital signature. In this pre-screen, the rms values obtained in Scan Step S8 are compared against the corresponding stored values in the database record of the hit. The ‘hit’ is rejected from further processing if the respective average values do not agree within a predefined range. The article is then rejected as non-verified (i.e. jump to Verification Step V6 and issue fail result).

Verification Step V4 is a further optional pre-screening test that is performed before analysing the full digital signature. In this pre-screen, the cross-correlation coefficients (if any) obtained in optional Scan Step S7 are compared against the corresponding stored values in the database record of the hit. The ‘hit’ is rejected from further processing if the respective cross-correlation coefficients do not agree within a predefined range. The article is then rejected as non-verified (i.e. jump to Verification Step V6 and issue fail result).

Another check using the cross-correlation coefficients that could be performed in Verification Step V4 is to check the width of the peak in the cross-correlation function, where the cross-correlation function is evaluated by comparing the value stored from the original scan in Scan Step S7 above and the re-scanned value:

$${Γ}_{k , l} ( j ) = \frac{{\sum }_{i = 1}^{N} {a}_{k} ( i ) {a}_{l} ( i + j )}{\sqrt{( {\sum }_{i = 1}^{N} {{a}_{k} ( i )}^{2} ) ( {\sum }_{i = 1}^{N} {{a}_{l} ( i )}^{2} )}}$$

If the width of the re-scanned peak is significantly higher than the width of the original scan, this may be taken as an indicator that the re-scanned article has been tampered with or is otherwise suspicious. For example, this check should beat a fraudster who attempts to fool the system by printing a bar code or other pattern with the same intensity variations that are expected by the photodetectors from the surface being scanned.

Verification Step V5 is the main comparison between the scanned digital signature obtained in Scan Step S5 and the corresponding stored values in the database record of the hit. The full stored digitised signature, dₖ^{db}(i) is split into n blocks of q adjacent bits on k detector channels, i.e. there are qk bits per block. In the present example where k=1 for a standard flatbed, sheetfeed or handheld document scanner, a typical value for q is 4, making typically 4 bits per block. The qk bits are then matched against the qk corresponding bits in the stored digital signature dₖ^{db}(i+j). If the number of matching bits within the block is greater or equal to some pre-defined threshold Zₜₕᵣₑₛₕ, then the number of matching blocks is incremented. A typical value for Zₜₕᵣₑₛₕ is 3 on a one detector (k=1) system. This is repeated for all n blocks. This whole process is repeated for different offset values of j, to compensate for errors in placement of the scanned area, until a maximum number of matching blocks is found. Defining M as the maximum number of matching blocks, the probability of an accidental match is calculated by evaluating:

$$p ( M ) = {\sum }_{w = n - M}^{n} {{s}^{w} ( 1 - s )}^{n - w} {}_{w}^{n} C$$

where s is the probability of an accidental match between any two blocks (which in turn depends upon the chosen value of Z_{threshold}), M is the number of matching blocks and p(M) is the probability of M or more blocks matching accidentally. The value of s is determined by comparing blocks within the database from scans of different objects of similar materials, e.g. a number of scans of paper documents etc. For an example case of q=4, k=2 and Z_{threshold}=7, we find a typical value of s is 0.1. If the qk bits were entirely independent, then probability theory would give s=0.01 for Z_{threshold}=7. The fact that we find a higher value empirically is because of correlations between the k detector channels (if multiple detectors are used) and also correlations between adjacent bits in the block due to the width of the light beam passed to each sensor in the array by the lens arrangement. A typical scan of a piece of paper yields around 314 matching blocks out of a total number of 510 blocks, when compared against the data base entry for that piece of paper. Setting M=314, n=510, s=0.1 for the above equation gives a probability of an accidental match of 10⁻¹⁷⁷. As mentioned above, these figures apply to a four detector channel system. The same calculations can be applied to systems with other numbers of detector channels.

Verification Step V6 issues a result of the verification process. The probability result obtained in Verification Step V5 may be used in a pass/fail test in which the benchmark is a pre-defined probability threshold. In this case the probability threshold may be set at a level by the system, or may be a variable parameter set at a level chosen by the user. Alternatively, the probability result may be output to the user as a confidence level, either in raw form as the probability itself, or in a modified form using relative terms (e.g. no match/poor match/good match/excellent match) or other classification. In experiments carried out upon paper, it has generally been found that 75% of bits in agreement represents a good or excellent match, whereas 50% of bits in agreement represents no match.

By way of example, it has been experimentally found that a database comprising 1 million records, with each record containing a 128-bit thumbnail of the Fourier transform amplitude spectrum, can be searched in 1.7 seconds on a standard PC computer of 2004 specification. 10 million entries can be searched in 17 seconds. High-end server computers (and computers of more recent specification) can be expected to achieve speeds many times faster than this.

It will be appreciated that many variations are possible. For example, instead of treating the cross-correlation coefficients as a pre-screen component, they could be treated together with the digitised intensity data as part of the main signature. For example the cross-correlation coefficients could be digitised and added to the digitised intensity data. The cross-correlation coefficients could also be digitised on their own and used to generate bit strings or the like which could then be searched in the same way as described above for the thumbnails of the digitised intensity data in order to find the hits.

In one alternative example, step V5 (calculation of the probability of an accidental match) can be performed using a method based on an estimate of the degrees of freedom in the system. For example, if one has a total of 2000 bits of data in which there are 1300 degrees of freedom, then a 75% (1500 bits) matching result is the same as 975 (1300×0.75) independent bits matching. The uniqueness is then derived from the number of effective bits as follows:

$$p ( m ) = {\sum }_{w = n - m}^{n} {{s}^{w} ( 1 - s )}^{n - w} {}_{w}^{n} C$$

This equation is identical to the one indicated above, except that here m is the number of matching bits and p(m) is the probability of m or more blocks matching accidentally.

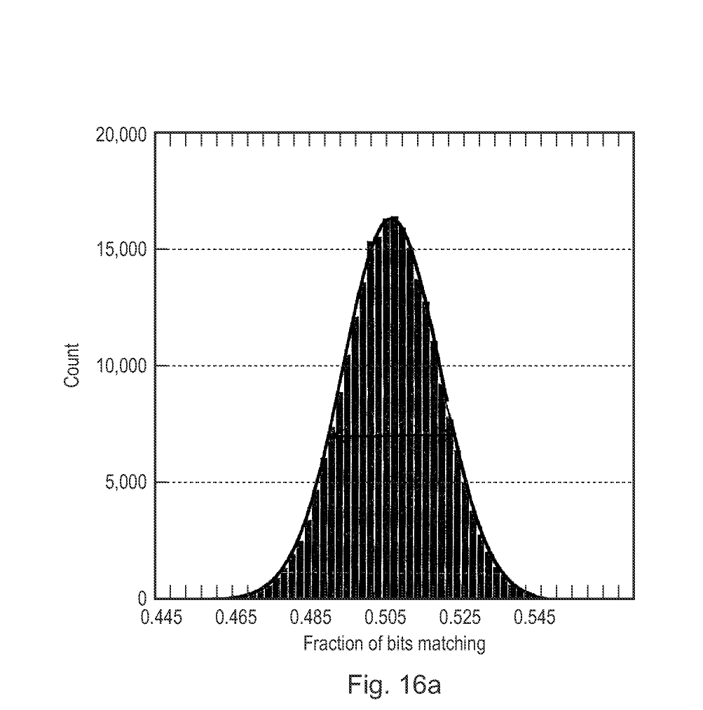

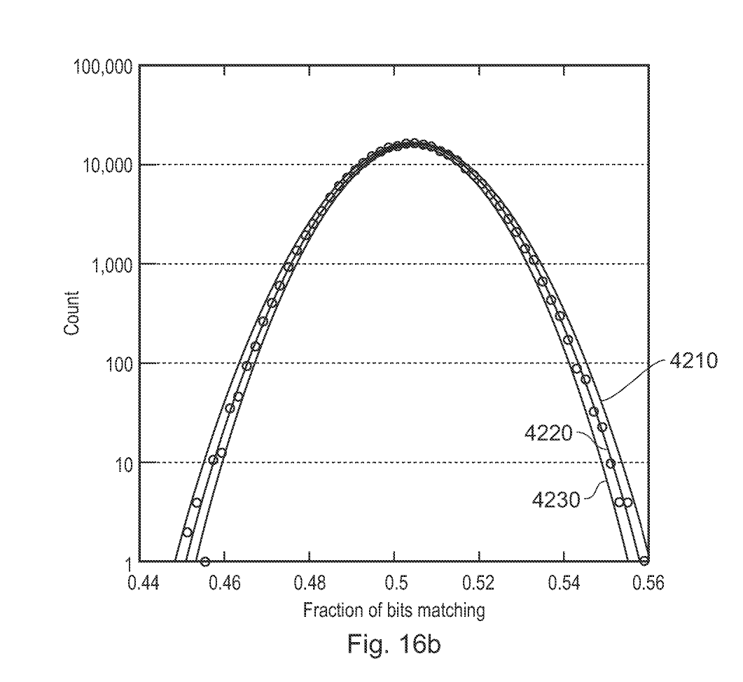

The number of degrees of freedom can be calculated for a given article type as follows. The number of effective bits can be estimated or measured. To measure the effective number of bits, a number of different articles of the given type are scanned and signatures calculated. All of the signatures are then compared to all of the other signatures and a fraction of bits matching result is obtained. An example of a histogram plot of such results is shown in FIG. 16a. The plot in FIG. 16a is based on 124,500 comparisons between 500 similar items, the signature for each item being based on 2000 data points. The plot represents the results obtained when different items were compared.

From FIG. 16a it can clearly be seen that the results provide a smooth curve centred around a fraction of bits matching result of approximately 0.5. For the data depicted in FIG. 16a, a curve can be fitted to the results, the mean μ of which curve is 0.504 and the standard deviation σ of which is 0.01218. From the fraction of bits matching plot, the number of degrees of freedom N can be calculated as follows:

$$N = μ \frac{1 - μ}{{σ}^{2}}$$

In the context of the present example, this gives a number of degrees of freedom N of 1685.

The accuracy of this measure of the degrees of freedom is demonstrated in FIG. 16b. This figure shows three binomial curves plotted onto the experimental of fraction of bits matching. Curve 4210 is a binomial curve with a turning point at 0.504 using N=1535, curve 4220 is a binomial curve with a turning point at 0.504 using N=1685, and curve 4230 is a binomial curve with a turning point at 0.504 using N=1835. It is clear from the plot that the curve 4220 fits the experimental data, whereas curves 4210 and 4230 do not.

For some applications, it may be possible to make an estimate of the number of degrees of freedom rather than use empirical data to determine a value. If one uses a conservative estimate for an item, based on known results for other items made from the same or similar materials, then the system remains robust to false positives whilst maintaining robustness to false negatives.

As will be appreciated, a document can be scanned for verification purposes and the results presented to a user. First the document can be scanned according to the scanning steps of FIG. 14. The document authenticity is then verified using the verification steps of FIG. 15. If there is no matching record in the database, a “no match” result can be displayed to a user. If there is a match, this can be displayed to the user using a suitable user interface. The user interface may be a simple yes/no indicator system such as a lamp or LED which turns on/off or from one colour to another for different results. The user interface may also take the form of a point of sale type verification report interface, such as might be used for conventional verification of a credit card. The user interface might be a detailed interface giving various details of the nature of the result, such as the degree of certainty in the result and data describing the original article or that article's owner. Such an interface might be used by a system administrator or implementer to provide feedback on the working of the system. Such an interface might be provided as part of a software package for use on a conventional computer terminal.

It will thus be appreciated that when a database match is found a user can be presented with relevant information in an intuitive and accessible form which can also allow the user to apply his or her own common sense for an additional, informal layer of verification. For example, if the article is a document, any image of the document displayed on the user interface should look like the document presented to the verifying person, and other factors will be of interest such as the confidence level and bibliographic data relating to document origin. The verifying person will be able to apply their experience to make a value judgement as to whether these various pieces of information are self consistent.

Thus there have now been described methods for scanning an article to create a signature therefrom and for comparing a resulting scan to an earlier record signature of an article to determine whether the scanned article is the same as the article from which the record signature was taken. These methods can provide a determination of whether the article matches one from which a record scan has already been made to a very high degree of accuracy.

From one point of view, there has thus now been described, in summary, a system in which a digital signature is obtained by digitising a set of data points obtained by scanning a non-coherent beam over a paper, cardboard or other article, and measuring the surface roughness information carried by the reflections therefrom. A thumbnail digital signature is also determined, either in realspace by averaging or compressing the data, or by digitising an amplitude spectrum of a Fourier transform of the set of data points. A database of digital signatures and their thumbnails can thus be built up. The authenticity of an article can later be verified by re-scanning the article to determine its digital signature and thumbnail, and then searching the database for a match. Searching is done on the basis of the Fourier transform thumbnail to improve search speed. Speed is improved, since, in a pseudo-random bit sequence, any bit shift only affects the phase spectrum, and not the amplitude spectrum, of a Fourier transform represented in polar co-ordinates. The amplitude spectrum stored in the thumbnail can therefore be matched without any knowledge of the unknown bit shift caused by registry errors between the original scan and the re-scan.

In some examples, the method for extracting a signature from a scanned article can be optimised to provide reliable recognition of an article despite deformations to that article caused by, for example, stretching or shrinkage. Such stretching or shrinkage of an article may be caused by, for example, water damage to a paper or cardboard based article.

Also, an article may appear to a scanner to be stretched or shrunk if the relative speed of the article to the sensors in the scanner is non-linear. This may occur if, for example the article is being moved along a conveyor system, or if the article is being moved through a scanner by a human holding the article. An example of a likely scenario for this to occur is where a human scans, for example, a bank card using a swipe-type scanner.

In some examples, where a scanner is based upon a scan head which moves within the scanner unit relative to an article held stationary against or in the scanner, then linearisation guidance can be provided within the scanner to address any non-linearities in the motion of the scan head. Where the article is moved by a human, these non-linearities can be greatly exaggerated

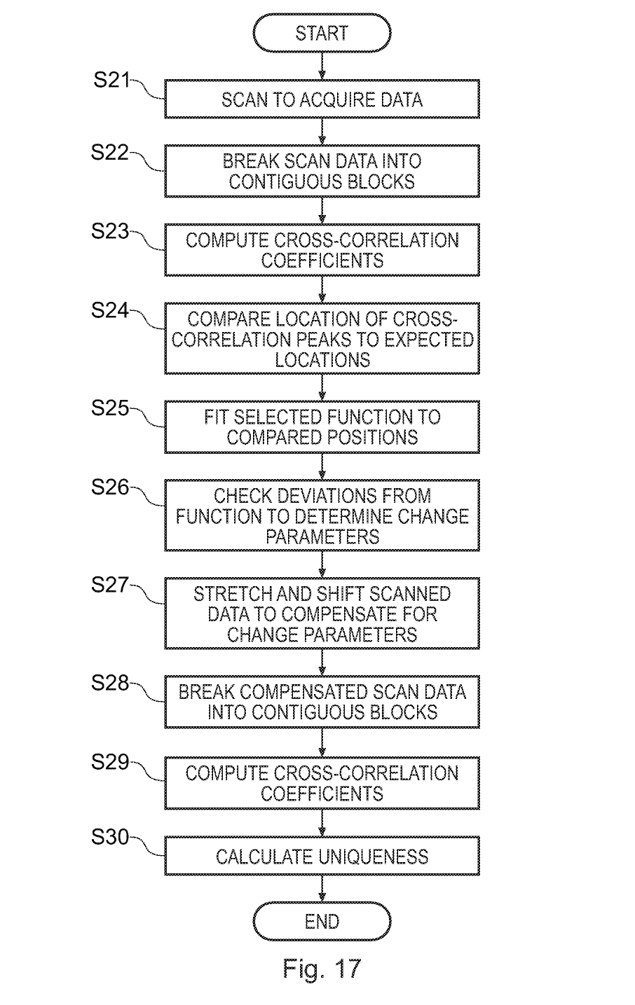

To address recognition problems which could be caused by these non-linear effects, it is possible to adjust the analysis phase of a scan of an article. Thus a modified validation procedure will now be described with reference to FIG. 17. The process implemented in this example uses a block-wise analysis of the data to address the non-linearities.

The process carried out in accordance with FIG. 17 can include some or all of the steps of time domain filtering, alternative or additional linearisation, space domain filtering, smoothing and differentiating the data, and digitisation for obtaining the signature and thumbnail described with reference to FIG. 14, but are not shown in FIG. 17 so as not to obscure the content of that figure.

As shown in FIG. 17, the scanning process for a validation scan using a block-wise analysis starts at step S21 by performing a scan of the article to acquire the date describing the intrinsic properties of the article. This scanned data is then divided into contiguous blocks (which can be performed before or after digitisation and any smoothing/differentiation or the like) at step S22. In one example, a scan area of 1600 mm² (e.g. 40 mm×40 mm) is divided into eight equal length blocks. Each block therefore represents a subsection of the scanned area of the scanned article.

For each of the blocks, a cross-correlation is performed against the equivalent block for each stored signature with which it is intended that article be compared at step S23. This can be performed using a thumbnail approach with one thumbnail for each block. The results of these cross-correlation calculations are then analysed to identify the location of the cross-correlation peak. The location of the cross-correlation peak is then compared at step S24 to the expected location of the peak for the case where a perfectly linear relationship exists between the original and later scans of the article.

As this block-matching technique is a relatively computationally intensive process, in some examples its use may be restricted to use in combination with a thumbnail search such that the block-wise analysis is only applied to a shortlist of potential signature matches identified by the thumbnail search.

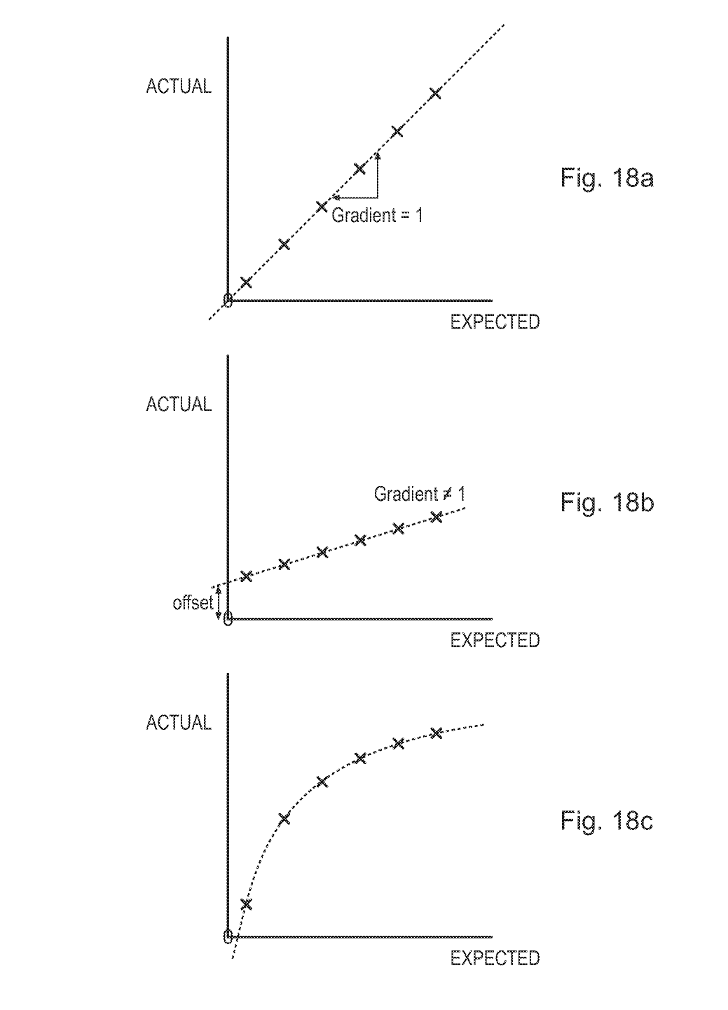

This relationship can be represented graphically as shown in FIGS. 18A, 18B and 18C. In the example of FIG. 18A, the cross-correlation peaks are exactly where expected, such that the motion of the scan head relative to the article has been perfectly linear and the article has not experienced stretch or shrinkage. Thus a plot of actual peak positions against expected peak results in a straight line which passes through the origin and has a gradient of 1.

In the example of FIG. 18B, the cross-correlation peaks are closer together than expected, such that the gradient of a line of best fit is less than 1. Thus the article has shrunk relative to its physical characteristics upon initial scanning. Also, the best fit line does not pass through the origin of the plot. Thus the article is shifted relative to the scan head compared to its position for the record scan.

In the example of FIG. 18C, the cross correlation peaks do not form a straight line. In this example, they approximately fit to a curve representing a y² function. Thus the movement of the article relative to the scan head has slowed during the scan. Also, as the best fit curve does not cross the origin, it is clear that the article is shifted relative to its position for the record scan.

A variety of functions can be test-fitted to the plot of points of the cross-correlation peaks to find a best-fitting function. Thus curves to account for stretch, shrinkage, misalignment, acceleration, deceleration, and combinations thereof can be used. Examples of suitable functions can include straight line functions, exponential functions, a trigonometric functions, x² functions and x³ functions.

Once a best-fitting function has been identified at step S25, a set of change parameters can be determined which represent how much each cross-correlation peak is shifted from its expected position at step S26. These compensation parameters can then, at step S27, be applied to the data from the scan taken at step S21 in order substantially to reverse the effects of the shrinkage, stretch, misalignment, acceleration or deceleration on the data from the scan. As will be appreciated, the better the best-fit function obtained at step S25 fits the scan data, the better the compensation effect will be.

The compensated scan data is then broken into contiguous blocks at step S28 as in step S22. The blocks are then individually cross-correlated with the respective blocks of data from the stored signature at step S29 to obtain the cross-correlation coefficients. This time the magnitude of the cross-correlation peaks are analysed to determine the uniqueness factor at step S29. Thus it can be determined whether the scanned article is the same as the article which was scanned when the stored signature was created.

Accordingly, there has now been described an example of a method for compensating for physical deformations in a scanned article, and/or for non-linearities in the motion of the article relative to the scanner. Using this method, a scanned article can be checked against a stored signature for that article obtained from an earlier scan of the article to determine with a high level of certainty whether or not the same article is present at the later scan. Thereby an article constructed from easily distorted material can be reliably recognised. Also, a scanner where the motion of the scanner relative to the article may be non-linear can be used, thereby allowing the use of a low-cost scanner without motion control elements.

Another characteristic of an article which can be detected using a block-wise analysis of a signature generated based upon an intrinsic property of that article is that of localised damage to the article. For example, such a technique can be used to detect modifications to an article made after an initial record scan.

For example, many documents, such as passports, ID cards and driving licenses, include photographs of the bearer. If an authenticity scan of such an article includes a portion of the photograph, then any alteration made to that photograph will be detected. Taking an arbitrary example of splitting a signature into 10 blocks, three of those blocks may cover a photograph on a document and the other seven cover another part of the document, such as a background material. If the photograph is replaced, then a subsequent rescan of the document can be expected to provide a good match for the seven blocks where no modification has occurred, but the replaced photograph will provide a very poor match. By knowing that those three blocks correspond to the photograph, the fact that all three provide a very poor match can be used to automatically fail the validation of the document, regardless of the average score over the whole signature.

Also, many documents include written indications of one or more persons, for example the name of a person identified by a passport, driving license or identity card, or the name of a bank account holder. Many documents also include a place where written signature of a bearer or certifier is applied. Using a block-wise analysis of a signature obtained therefrom for validation can detect a modification to alter a name or other important word or number printed or written onto a document. A block which corresponds to the position of an altered printing or writing can be expected to produce a much lower quality match than blocks where no modification has taken place. Thus a modified name or written signature can be detected and the document failed in a validation test even if the overall match of the document is sufficiently high to obtain a pass result.

The area and elements selected for the scan area can depend upon a number of factors, including the element of the document which it is most likely that a fraudster would attempt to alter. For example, for any document including a photograph the most likely alteration target will usually be the photograph as this visually identifies the bearer. Thus a scan area for such a document might beneficially be selected to include a portion of the photograph. Another element which may be subjected to fraudulent modification is the bearer's signature, as it is easy for a person to pretend to have a name other than their own, but harder to copy another person's signature. Therefore for signed documents, particularly those not including a photograph, a scan area may beneficially include a portion of a signature on the document.

In the general case therefore, it can be seen that a test for authenticity of an article can comprise a test for a sufficiently high quality match between a verification signature and a record signature for the whole of the signature, and a sufficiently high match over at least selected blocks of the signatures. Thus regions important to the assessing the authenticity of an article can be selected as being critical to achieving a positive authenticity result.

In some examples, blocks other than those selected as critical blocks may be allowed to present a poor match result. Thus a document may be accepted as authentic despite being torn or otherwise damaged in parts, so long as the critical blocks provide a good match and the signature as a whole provides a good match.

Thus there have now been described a number of examples of a system, method and apparatus for identifying localised damage to an article, and for rejecting an inauthentic an article with localised damage or alteration in predetermined regions thereof. Damage or alteration in other regions may be ignored, thereby allowing the document to be recognised as authentic.

As the scan system of the present examples can capture details of surface printing (being as how the scanner apparatus is a conventional image scanner), it is possible to include a barcode within the scan area. The barcode could be used as an alignment mark for positioning of the scanner. A suitable barcode might be the standard PDF417 2-D barcode or the standard DataMatrix 2-D barcode. Assuming that the barcode itself is not used for generation of the signature, the barcode can be printed onto the article after a database population scan has taken place. Therefore, the barcode can include the article signature or some other article identifier. At a later validation scan, the scanner can read the barcode to retrieve the signature or the identifier. Therefore, with the signature read from the article encoded thereonto, it is possible to validate the article against the record signature without access to a database of signatures. Thereby an article can be validated in a location remote from a connection to a database of authentic signatures.

Alternatively, if the scanner has database access, the signature encoded onto the article can be sued to retrieve an authentic signature from the database, such that the authenticity check can be performed as a 1:1 check, as it will be known in advance what signature is expected. Thus the authenticity check can be performed much more quickly than in a circumstance where the expected signature is unknown and a 1:many check must be performed though a database of signatures.

The implementation of such a system may advantageously be arranged to print the barcode to the article as soon as possible after creating the record signature therefore. This can aid ensuring that the printed barcode is the correct one for the particular article in question. This could be of relevance in an environment where articles are being scanned in very quick succession.

A barcode system could be implemented by scanning a portion of the article to be secured and using the signature from that portion to encode into a barcode for immediate printing onto a different region of the article. In other words, the barcode was originally applied at the time of manufacture of the article by scanning the scan region of the article and then printing the barcode onto the barcode area. The article is thus labelled with a signature characteristic of its intrinsic structure, namely the surface structure in the scan region.

Where the barcode includes the actual signature for the item, validation of that item can be carried out without a connection to a database of signatures. In fact if all items to be validated are marked using a barcode in this manner, a database of signatures may be omitted entirely. Such a system might be advantageous where privacy concerns relating to the maintenance of such a database could be a problem. Such a system might also be advantageous where it might be desired to validate an item in a location from where access to a database is not available.

Where the article includes information describing the bearer, such as a passport, identity card, driving license or bank/credit/loyalty card, an OCR operation could be carried out on the capture data to read the bearer information. This bearer information might be a name or might be an identifier number such as a passport number. Using the bearer information, an expected signature for the article can be retrieved, and used to check against the signature calculated from the scan data. It may be considerably quicker to find a name or number in a database and to retrieve a signature associated therewith than to check a determined signature against all stored signatures in the database. Thus the signature-based validation process is a 1:1 check rather than a 1:many check.

Other systems which could achieve a 1:1 search strategy could use bearer information embedded in a different carrier of the card to retrieve the expected signature. This could include a magnetic strip on the article or a microchip embedded in the article, as will be discussed in greater detail below.

It will be appreciated that this basic approach can be used to mark a wide variety of articles with a label that encodes the articles own signature obtained from its intrinsic physical properties, for example any printable article, including paper or cardboard articles or plastic articles.

Given the public nature of the barcode or other label that follows a publicly known encoding protocol, it may be advisable to make sure that the signature is in some way protected before being encoded into the barcode. This may be performed by digitally signing the signature or applying an asymmetric encryption algorithm for creation of the barcode, i.e. a one-way function is used, such as according to the well known RSA algorithm.

In one example, the label can represent a public key based encryption of the signature in a public key/private key encryption system. If the system is used by a number of different customers, it may be advisable that each customer has its own private key, so that disclosure of a private key will only affect one customer. The label is thus encoded with the public key and the private key is located securely with the authorised persons.

In one example, to avoid a forger creating a fake item, and then scanning it and creating a signature, which signature is then encoded in a barcode on the fake item (such that the item validates against itself but would not validate against a database) the signature in the barcode can be protected to make forgery in this manner much more difficult, or even impossible. For example, the barcode could additionally contain a digitally signed hashing result from the signature. Thus, when checking the signature for the article, the signature encoded in the barcode can be checked against the digitally signed hash result from the signature. If this check is failed, or if the digital signature used for signing the hash function is incorrect or not recognised, the article can be rejected as fake.

In some examples, the encryption could be symmetric. In this case the key could be held securely in tamper-proof memory or crypto-processor smart cards on the document scanners. Alternatively, symmetric encryption could be used to encrypt the actual data (the signature) and an asymmetric encryption system to encrypt the symmetric encryption key.

A further perceived advantage of the labelling approach is that a novice user would be unaware of the verification being carried out without special knowledge. It would be natural for the user to assume that the reader apparatus was simply a barcode scanner, and it was the barcode that was being scanned.

In one example, for CD's, DVD's or other content bearing disks, the signature is on the disk and forms part of a decryption key for the data on the disk. The disk player then reads the speckle signature from the disk when reading the data.

As noted above, the labelling scheme could be used to allow articles to be verified without access to a database purely on the basis of the label.

However, it is also envisaged that the labelling scheme could be used in combination with a database verification scheme. In an example where the article would not normally carry bearer identification (such as where the article is a saleable product), the barcode could encode a thumbnail form of the digital signature and be used to allow a rapid pre-screen prior to screening with reference to a database. This could be a very important approach in practice, since potentially in some database applications, the number of records could become huge (e.g. millions) and searching strategies would become critical. Intrinsically high speed searching techniques, such as the use of bitstrings, could become important

As an alternative to the barcode encoding a thumbnail, the barcode (or other label) could encode a record locator, i.e. be an index or bookmark, which can be used to rapidly find the correct signature in the database for further comparison.

Another variant is that the barcode (or other label) encodes a thumbnail signature which can be used to get a match with reasonable but not high confidence if a database is not available (e.g. temporarily off-line, or the scanning is being done in an unusually remote location without internet access). That same thumbnail can then be used for rapid record locating within the main database if the database is available, allowing a higher confidence verification to be performed.

An article, such as an ID card, may include a data carrying chip and thus is a so-called smart card. The data carried by the chip can include signature encoding data that encodes a digital signature obtained from an intrinsic measured surface characteristic of the ID card obtained from a scan area (which may be featureless in one example, but could be decorated in any desired way, or contain a photograph, for example).

In other examples, the data carrying chip can carry other data which may identify the expected signature of the article. This may include bearer information for the bearer of the card. The bearer information could be used to search a database to return an expected signature for the article. The expected signature can then be compared to a signature created by scanning the article and a validation result returned. This example provides that the signature verification is a 1:1 check, with the database search being based on a search for a well-defined data string (e.g. name of bearer) in a conventional manner. This could be expected to result in a faster overall time from scan to validation result than where the signature check is a 1:many signature check using the signature and/or signature thumbnail to search the database.

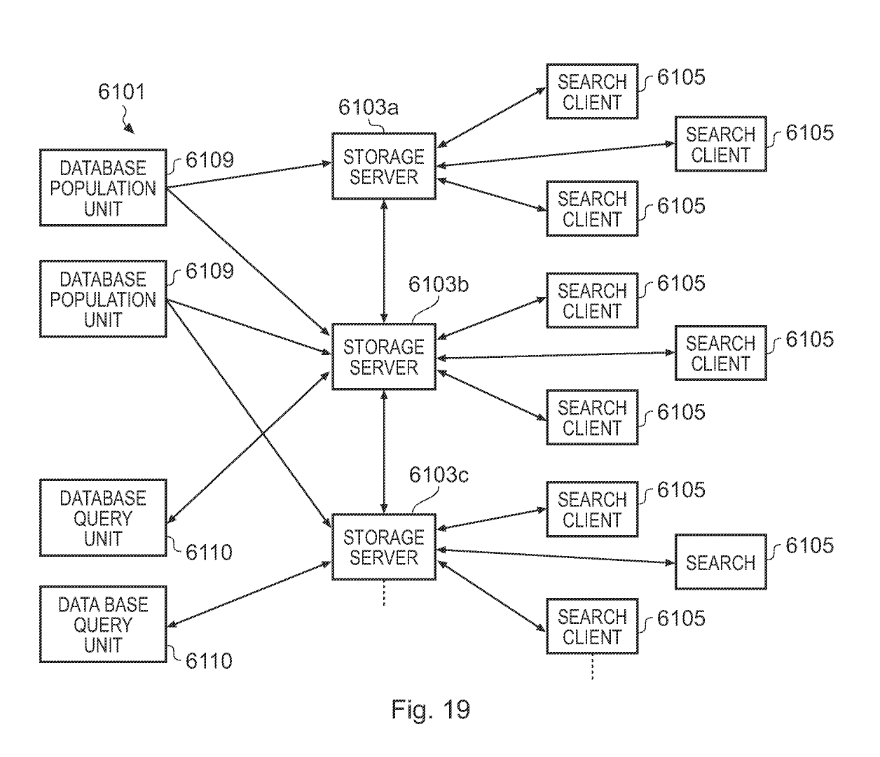

In the above examples, there are various discussions of storing a signature determined from an article to a database for later reference. There are also various discussions of comparing a signature determined from an article to a stored signature within a database. With reference to FIG. 19, there will now be described an example of a database structure which may be used to implement a central signature database in which signatures can be stored and against the content of which signatures can be validated.

A database to store and retrieve signatures derived from an article surface in the manner described above is inherently difficult to create using commonplace database techniques. This is because the signature itself is essentially a random sequence. Thus it is not possible to utilise a hierarchical search based upon indices described in index tables. There are, in some examples at least, the thumbnails for the signatures—however as these are still essentially random, they present the same problems as the full signature.

Also, every scanning of a given target surface will produce a very slightly different signature. The different signatures generated by the same surface are, as is discussed in detail above, much more similar than the signatures from different surfaces but it is still the case that an exact 100% match would be highly unusual if not impossible. It is clear therefore that the match required in the database search is a fuzzy match.

As a result of these factors, it is becomes apparent that the only way to search a database for a signature match is to test every record in the database against a candidate signature. As noted above, the effect of this can be minimised if the thumbnail signatures are used to draw up a shortlist of possible matches and the full signatures are only tested for the signatures on the shortlist. However, even using the thumbnails, this search process is likely to be very computationally intensive.

However, with the benefit of modern microprocessor architectures, the search process can be carried out very efficiently provided that the data through which the search is to be conducted is held in fast access storage, such as the RAM of a conventional computer system. If the amount of data to search through has to be held partially in slower storage, such as a hard disk drive, there can quickly arise a situation where time taken to transfer the data from the hard disk to RAM can take longer than the time taken by the processor to carry out the search. It is thus clear, that to provide the fastest possible response time, the entire database needs to be held in fast access storage such as system RAM all of the time. It is desirable for database search results to be returning in the least possible time, as delays in receiving database search results may disincentivise users of the security system to rely upon it.

A fundamental problem with implementing such a system in modern computers is that the world's best known and most used consumer and enterprise operating system, Microsoft™ Windows™, is notoriously unstable, with so-called crashes occurring at regular intervals. Whilst current versions of Windows™ are much more reliable than previous versions, they still do not have the stability required to be relied upon for a RAM based database search system which is required to return search results as fast as possible. Other operating systems, such as UniX™ and Unix-like systems (Irix™, Linux™, FreeBSD™ etc) provide higher reliability than Windows™ in most circumstances. However this is still not sufficient for to be relied upon for a RAM based database search system which is required to return search results as fast as possible.

At the other end of the scale, there are dedicated specialist database architectures with proprietary operating systems which provide up to Class 5 reliability (99.999% availability) such as those used by telecoms operators to track calls made by telephone system users. Such systems tend to be somewhat expensive and, as they tend to concentrate on ensuring absolutely complete transaction logging, may not provide the speed required for use in the presently discussed systems.

As will be appreciated, the database architecture adopted can be based upon the requirements of the database in terms of size of database, desired availability of database, desired search speed and other factors. Thus, not withstanding the above discussion, for a small system where only a small number of signatures is to be used (up to a few hundred for example) and where availability is not of prime importance (i.e. these is not going to be a user stood waiting for a result in order to gain access to an event or location, or to complete a purchase), a simple system using a single computer having the entire database stored in RAM and running a Windows™ or Unix™-type operating system may be sufficient.

However, for a large system where many thousands or even millions of signatures are to be stored reliably and searched quickly, an architecture such as that illustrated in FIG. 19 may be adopted.

FIG. 19 schematically illustrates a database architecture 6101. The database architecture 6101 includes a set of storage servers 6103 (6103a, 6103b, 6103c) which, in the present example, are located within a single addressable logical domain. The storage servers 6103 need not be co-located, and may be distributed between different racks, rooms, buildings, regions and/or countries. In the present example the storage servers 6103 are each computer systems which are servers in the conventional sense, i.e. they may have one or more of a server operating system, a server class processor architecture, redundant power supply and redundant storage. These storage servers 6103 between them hold the entire database in non-volatile memory, such as in redundant storage such as RAID based system. In some examples, each database record (a signature, associated thumbnail and any metadata) is held by more than one of the storage servers 6103. In one example the database may include 5 storage servers with each database record being held by two or three of the storage servers.

Each storage server 6103 has associated therewith a number of search clients 6105. In one example, each storage server has between 2 and 10 search clients associated therewith. The search clients 6105 need not be included within the storage server domain as they do not need to be individually addressable by any computer other the associated storage server 6103. The search clients 6105 need not be based on specialist server hardware or software, and can in fact be any computer system capable of running a search query with sufficient speed. In some examples, a search server 6105 can be a simple computer with a processor (such as an Intel Pentium™, Intel Core™, AMD Athlon64™, AMD Sempron™, AMD Turion™ or VIA C3™ architecture processor), a large quantity of RAM (e.g. 1, 2, 4 or more GB), a small amount of non-volatile storage for storing an operating system and query processing software and a network interface to enable it to communicate with the storage server. The primary requirement for a search client 6105 is the capability to process the signature comparisons sufficiently quickly.

Each search client 6105 stores within local RAM a subset of the database records held by the associated storage server. These locally held records are then searched through when a search query is received. To provide greater reliability, each record held by the storage server may be sent to multiple ones of the associated search servers. Each search client may also store its database subset in local non-volatile storage (such as a hard disk drive), thus allowing the search client to be brought online rapidly after a software crash on that client. In the event of the client suffering a hard disk drive failure the database records can be resent from the storage server to the search client.

The database architecture shown in FIG. 19 can be populated as follows. A database population unit 6109 provides new signatures to a number of the storage servers 6103. The database population unit 6109 may be, for example, some form of production line scanner whether for articles such as packets, boxes or cartons, or for articles such as identity or entitlement documents. As shown in FIG. 19, each database population unit sends new records to a subset of the storage servers 6103. If only one database population unit 6109 is to be used, the storage servers 6103 to which the records are sent may include all of the storage servers or a changing subset thereof. Alternatively, a recipient storage server may pass the record on to other storage servers with or without keeping a copy for itself.

The database may be searched by sending queries from a database query unit 6111. In the present example each database query unit 6111 sends a query to a single storage server 6103, from where it is distributed to all other storage servers. In the present example, where the storage servers are located in a single logical domain, a query may in fact be addressed to the domain, where it is handled by the storage servers. Each storage server then passes the query on to its associated search servers. Thus it is clear that due to the replication of each database record across more than one storage server, and due to the possible replication of each record from each storage server across more than one search clients, that each database record is in fact considered by at least two (and possibly more) search servers in response to each query. It is noted that this duplication of effort is potentially wasteful, however it is presently considered to be more efficient to duplicate search effort in this way than to spend the time and management effort required to implement a system where one search client is the “primary” repository of a record and all other search clients holding that record are “secondary” or “hot-standby” repositories of that record and to check whether the primary repository is available, and in dependence upon the primary status to designate a secondary repository to handle the query.

In examples where each record includes a thumbnail of the signature in that record, a query may send both a thumbnail and signature with a coordinating storage server carrying out the role of creating a shortlist of records based on the thumbnail search result and then performing a targeted search of the shortlist entries. In other examples, a query may include only the thumbnail, with the full signature being sent for search against the shortlist only one the shortlist is received at the database query unit. In still further examples, a search clients may carry out the full signature comparison immediately if a thumbnail match is found. Thus, there is never really an actual “shortlist” compiled but the processing which takes place provides the same effect as if one were. In other examples the query may include only the signature and the search server may be tasked with creating the thumbnail for searching. In this example, where the thumbnail is never used outside of the storage and search environment, the thumbnail generation algorithm can be chosen independently of the signature generation apparatus. Thus a common signature generation apparatus can be used with both systems that use a simple subset thumbnail and systems that use a Fourier transform thumbnail with no modification to the signature generation apparatus.

Where the thumbnail search is being used, if a shortlist of possible hits is compiled, as the database may have no index, the shortlist can include an identity of the search clients which found each potential match so as to speed the subsequent full signature search. In some examples, the database may in fact include an index based on metadata associated with each record and/or assign a unique record number to each record. The metadata may include a creation data for the article, a serial number for the article (such as a passport, ID card, or bank card number), a batch number for the article (such as for a manufactured item such as a carton of cigarettes), an identifier of the owner of the article (for example for a passport, ID card or bank card), an article type (where the database contains records for multiple article types) etc. Such indexed data can then be used to identify the records which are present on the shortlist such that the full signature scan can be targeted at the specific records which were identified in the shortlist.

In some examples, it may be desirable to guarantee the authenticity of a signature within the database (to prevent a fraudster populating the database with signatures for fraudulent articles). To facilitate this, each article signature may be signed using a digital signature at the time of article signature creation. Thus a system used for creating article signatures could have a security signature module, for example a signature dongle in the case of the article signature generation system having a conventional computer connectivity port.

In some examples it may be desirable to ensure that the signing of the article signature is performed using the private key of an asymmetric public/private key pair. Thereby the corresponding public key can be used at the database to check the digital signature of the article signature to verify the authenticity of the article signature with the benefit all of the advantages of asymmetric key pair signing.

In some examples it may be desirable to ensure that the key or certificate used for digitally signing the article signature is stored locally to the signature generating apparatus. This could, for example, include storing the signature in a computer used for the signature generation process or by including the signature on a token securely installed within the scanner apparatus. Thereby the only way for a fraudster to populate the database with signatures of fraudulent items would be to steal a genuine signature generation apparatus.

In some examples the public key held at the database may itself need to be signed by one or more trusted third parties to ensure that the public key in use is a genuine key, and not one which has been inserted into the database by a fraudster. Thereby a fraudster could neither hack into the database system to insert a public key corresponding to the private key of a fraudulent signature generation apparatus, nor exert in nefarious manner pressure on a human database administrator to insert such a public key into the database. In one example a public key for use in the database in verifying the authenticity of signatures received from a remote signature generation apparatus may need to be independently authenticated by three or four independent trusted third parties. Such third parties may include trusted certification authorities.

In some examples, the article signature can be further protected by encrypting it, at the time of creation for transfer to the database. It may then be stored encrypted or decrypted for storage. This encryption could take the form of creating a symmetric encryption algorithm key for an article signature, or by using a one time pad based system.

In some examples, to provide maximum security and confidence in the content of the database, a manual audit process may be instituted. Under such a process, an independent auditor may visit a signature generation apparatus (for example at a production line where articles are produced and then scanned) to ensure that the signature generation apparatus is present and intact (i.e. has not been tampered with, misaligned or damaged). Thereby it can be determined that all signatures created by a signature generation apparatus and used to populate the database are in fact genuine signatures of genuine articles.

Thus there have now been described various examples of how a database system for storing and searching article signatures may be implemented.

Many other variations of the invention will be envisaged by the skilled person in addition to those specifically mentioned above.

1. A method of creating a signature for an article, the method comprising:
illuminating regions of the article sequentially by light at non-normal incidence;
detecting light reflected from the surface of each region of the article; and
processing signals representative of the reflected light from each region, the signals being indicative of a surface roughness of the region, to determine a signature for the article.

2. The method of claim 1, wherein the illuminating and detecting are carried out using a document scanner device.

3. The method of claim 2, wherein the document scanner device is a flatbed scanner device.

4. The method of claim 2, wherein the document scanner device is a sheetfeed scanner device.

5. The method of claim 2, wherein the document scanner device is a multi-function device or a digital photocopier.

6. The method of claim 1, wherein the illuminating comprises directing non-coherent light onto each region sequentially.

7. The method of claim 1, wherein the detecting comprises focussing the reflected light onto a photodetector array using a lens array, each lens in the lens array corresponding to a respective photodetector, and each lens in the lens array being configured to collect light reflected from a respective different part of the region for each region.

8. The method of claim 1, further comprising creating a thumbnail signature from the signature.

9. A method of validating an article comprising:
creating a first signature for the article according to the method of any preceding claim;
storing the first signature;
creating a second signature for the article according to the method of any preceding claim; and
comparing the second signature to the stored first signature to determine whether the same article has been used to create both signatures.

10. The method of claim 9, wherein the storing comprises storing the first signature in a database of stored signatures, and the comparing comprises comparing the second signature to the database of stored signatures to determine whether the second signature matches a signature in the database of stored signatures.

11. A system for creating a signature for an article, the system comprising:
a light source operable to direct light toward regions of the article sequentially at non-normal incidence;
a detector operable to detect light reflected from the surface of each region of the article; and
a processor operable to process signals representative of the reflected light from each region, the signals being indicative of a surface roughness of the region, to determine a signature for the article.

12. The system of claim 11 wherein the light source and the detector are part of a document scanner device.

13. The system of claim 12, wherein the document scanner device is a flatbed scanner device.

14. The system of claim 12, wherein the document scanner device is a sheetfeed scanner device.

15. The system of claim 12, wherein the document scanner device is a multi-function device or a digital photocopier.

16. The system of claim 11, wherein the light source is operable to direct non-coherent light onto each region sequentially.

17. The system of claim 11, wherein the detector comprises a lens array operable to focus the reflected light onto a photodetector array, each lens in the lens array corresponding to a respective photodetector, and each lens in the lens array being configured to collect light reflected from a respective different part of the region for each region.

18. The method of claim 11, further comprising creating a thumbnail signature from the signature.

19. A system for authenticating an article, the system comprising:
a system according to claim 11, operable to create a first signature for the article;
a store operable to store the first signature;
a system according to claim 11, operable to create a second signature for the article; and
a comparator operable to compare the second signature to the stored first signature to determine whether the same article has been used to create both signatures.

20. The system of claim 19, wherein the store comprises a database of stored signatures, and the comparator is operable to compare the second signature to the database of stored signatures to determine whether the second signature matches a signature in the database of stored signatures.
